(19) United States
(12) Patent Application Publication
(10) Pub. No.: US 2016/0092819 A1
(43) Pub. Date: Mar. 31, 2016

(54) ALLIANCE PARTNER DETERMINATION METHOD AND ALLIANCE PARTNER DETERMINATION APPARATUS

(71) Applicant: Hitachi, Ltd., Tokyo (JP)

(72) Inventors: Nobuyuki OTA, Tokyo (JP); Kouichi TANIMOTO, Tokyo (JP); Hirofumi TERADA, Tokyo (JP)

(73) Assignee: HITACHI, LTD., Tokyo (JP)

(21) Appl. No.: 14/713,922

(22) Filed: May 15, 2015

(30) Foreign Application Priority Data
Sep. 26, 2014 (JP) 2014-196851

(51) Int. Cl. G06Q 10/06; G06Q 10/10

(52) U.S. Cl. CPC G06Q 10/06375; G06Q 10/103

(57) ABSTRACT

An alliance partner determination apparatus allows a certain one of organizations, supporting each other in the occurrence of a given situation, to determine an alliance partner as a support requestee in order to cope with the situation. The apparatus includes: a situation analysis result acquisition unit acquiring information including a type and scale of the situation; and a supporter capacity calculation unit performing, based on the information including the type and scale of the situation, processing of: acquiring a response capacity available in the certain organization, and a support capacity of a partner organization already having built a support provision cooperation relationship with the certain organization, and estimating a reduction in the support capacity of the partner organization due to the situation to calculate an actually available support capacity of the partner organization. The partner organization and the available support capacity are outputted together from an output-input unit.

### CROSS-REFERENCE TO RELATED APPLICATION

The present application claims priority pursuant to 35 U.S.C. §119 from Japanese patent application no. 2014-196851, filed on Sep. 26, 2014, the entire disclosure of which is hereby incorporated herein by reference.

### BACKGROUND OF THE INVENTION

1. Field of the Invention

The present invention relates to an alliance partner determination method and an alliance partner determination apparatus.

2. Related Art

In preparation for the occurrence of a large-scale disaster or the like, cooperation agreements have been increasingly signed between various organizations including local governments such as prefectural, city, town, and village governments. In order to make such cooperation systems to function effectively, there has been a demand for a mechanism for smoothly forming links between supporters and support recipients. In this regard, Japanese Patent Application Laid-open Publication No. 2002-183380 (JP2002-183380A), for example, discloses a method and an apparatus of recruiting and dispatching supporters. JP2002-183380A discloses a technique for a method and an apparatus of registering supporter applicants together with their skills; and in reply to a request for a support operation, selecting registered supporter applicants who can promptly arrive at a requesting location by identifying the current locations of the respective supporter applicants, then quickly selecting the supporter applicants suitable for the activities of the support operation, inquiring of the selected supporter applicants whether or not to participate in the support operation, and dispatching the supporters selected based on replies to the participation possibility inquiries.

In the occurrence of a situation such as a disaster, however, the configuration described in JP2002-183380A also transmits participation possibility inquiries to supporters who have difficulty providing support due to an impact of the situation. For example, in the occurrence of an earthquake, participation possibility inquiries are sent to registered supporter applicants who are located in a region with a high seismic intensity of the earthquake. For this reason, the configuration described in JP2002-183380A transmits many inquiries whose transmission is unnecessary from the beginning, and causes a problem of an increase in burdens on communication networks. In addition, there is another problem in that a support requesting side cannot cope with the event quickly because the support operation for coping with the event is delayed during a waiting time for receiving the replies from the registered supporter applicants to which the inquiries have been transmitted.

### SUMMARY OF THE INVENTION

The present invention is made to solve the foregoing and other problems, and aims to reduce as much as possible transmission of support request inquiries unnecessary from the beginning, and to enable effective supporters to be rapidly gathered at a location of a support recipient.

To solve the foregoing and other problems, an aspect of the present invention provides an alliance partner determination apparatus for a certain one of a plurality of organizations which support each other in case of occurrence of a given situation, the apparatus configured to assist the certain organization to determine an alliance partner to which the certain organization is to make a support request in order to cope with the situation, the apparatus including: a situation analysis result acquisition unit configured to acquire information including a type and a scale of the situation occurring or having occurred; and a supporter capacity calculation unit configured to perform, based on the information including the type and the scale of the situation, processing of acquiring a response capacity available in the certain organization, and a support capacity expected to be provided by a partner organization that is another organization having already built a support provision cooperation relationship with the certain organization, and estimating a reduction in the support capacity of the partner organization due to the situation to calculate an available support capacity expected to be actually provided by the partner organization. The apparatus outputs information on the partner organization having the available support capacity and the available support capacity together.

Besides, the problems and solutions to them disclosed in the present application are clearly described in the section of detailed description of the invention and the drawings.

According to the present invention, it is possible to reduce as much as possible transmission of support request inquiries unnecessary from the beginning and to enable effective supporters to be rapidly collected at a location of a support recipient.

### BRIEF DESCRIPTION OF THE DRAWINGS

FIG. 1 is a conceptual diagram presenting possible factors for reducing support capacities;

FIG. 2 is a diagram illustrating an example of an overall configuration including alliance partner determination systems according to an embodiment of the present invention;

FIG. 3 is a system configuration example illustrating one example of an alliance partner determination apparatus 300;

FIG. 4 is a structure diagram presenting a specific example of an analysis result database 321;

FIG. 5 is a structure diagram presenting a specific example of an alliance status database 322;

FIG. 6 is a structure diagram presenting a specific example of a cooperation rule database 323;

FIG. 7A is a structure diagram presenting a specific example of a capacity database 324;

FIG. 7B is a structure diagram presenting a specific example of the capacity database 324;

FIG. 8 is a structure diagram presenting a specific example of an on-site need database 325;

FIG. 9 is a structure diagram presenting a specific example of a site-impact management database 326;

FIG. 10 is a diagram presenting an example of an alliance partner determination processing flow implemented by the alliance partner determination apparatus 300;

FIG. 11 is a diagram presenting an example of a detailed processing flow of a supporter capacity subtraction step in S1006 in FIG. 10;

FIG. 12 is a diagram presenting an example of a display screen in the alliance partner determination apparatus 300;

FIG. 13 is a diagram presenting an example of an owner organization capacity update processing flow in the alliance partner determination apparatus 300;

FIG. 14 is a diagram presenting an example of an alliance partner acceptability determination processing flow in the alliance partner determination apparatus 300 having received a support request; and

FIG. 15 is a diagram presenting an example of a reply screen on which the alliance partner determination apparatus 300 having received a support request generates a reply to a support requester.

### DETAILED DESCRIPTION OF THE INVENTION

Hereinafter, an embodiment for carrying out the present invention is described by using the drawings. In the present embodiment, an alliance partner determination system is assumed as follows. Specifically, in a situation where a large scale disaster occurs or a large scale event is held, for example, there may be a case where different organizations cope with the situation in alliance with each other by providing and receiving support to and from each other. In such a case, the alliance partner determination system of the present embodiment estimates whether or not each alliance partner candidate possesses a capacity that can be provided for support, and assists an organization to determine, based on the estimation results, an alliance partner to which the organization will make a support request, or an alliance partner which will receive support from the organization. It should be noted that the alliance partner determination system of the present embodiment is not intended to limit the present invention, and the present invention is applicable to any case where an organization works in alliance with other organizations by estimating the capacities of alliance partners, and by determining alliance partners.

The present embodiment is made on the assumption that a police organization of a certain one of prefectures copes with a situation where a torrential rain comes on during a large scale event held in a facility such as a stadium, for example, and that jurisdictional police stations, i.e., smaller organizational units in the police organization work in alliance with each other to take responding actions such as giving evacuation guidance to participants of the large scale event.

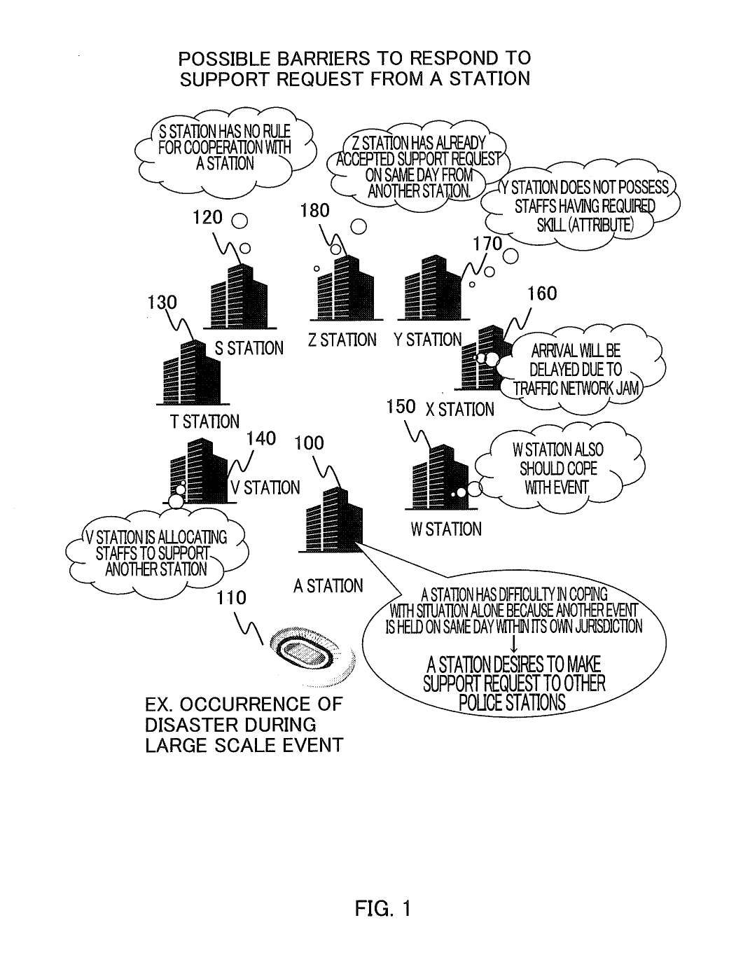

FIG. 1 is a conceptual diagram in the present embodiment illustrating a case where an organization cope with a given one of various situations in alliance with other organizations, and presenting a list of possible factors for reducing support capacities of the other organizations due to their occurring situations. The organization which will make support requests has to take these factors into account when estimating the support capacities expected to be provided by the other organizations. It should be noted that any support capacity reducing factor other than those presented in FIG. 1 may be added depending on properties and other elements of organizations to be analyzed.

In the example of FIG. 1, it is assumed that a heavy downpour occurs during a large scale event held in a stadium 110 within the jurisdiction of an A station 100 which is one of police stations under the control of a certain prefectural police headquarters, for example. To cope with the heavy downpour, the A station 100 responsible for the jurisdiction needs to take responding actions such as evacuation guidance. However, here, it is assumed that the A station 100 finds that the A station 100 by itself cannot execute all the necessary responding actions because another event is held on the same day within its own jurisdiction, for example. In this case, the A station 100 makes support requests to other police stations, i.e., an S station 120, a T station 130, a V station 140, a W station 150, an X station 160, a Y station 170, and a Z station 180.

In this case, it is expected that the other police stations, as support requestees which receive the support requests, even desire to support the A station 100 by using their own capacities, but have difficulty in supporting due to various factors. Such various factors may be exemplified in the following ways using, for example, “Five Ws and One H” questions which are referred to as points to be clarified to convey information:

When (temporal factor): Arrival at a support site is delayed due to a traffic network jam (the X station 160);

Where (location factor): Since a police station is located in a region affected by the event, the police station is also now taking the actions coping with the event and cannot allocate its own capacity any more to the support (the W station 150);

Who (factor related to support entity): A police station has not agreed in advance to provide support when a situation requiring support occurs (the police station has not signed a necessary cooperation agreement) (the S station 120);

What (factor related to what is to be provided for support): A police station does not possess categories and attributes of a capacity (human resources, relief supplies, and the like) requested by a support requester (the Y station 170);

Why (factor related to reason): A police station cannot allocate its own capacity to the A station 100 because it has already accepted a support request from another police station (the Z station 180); and

How (factor related to support framework): A police station cannot allocate its own capacity to the A station 100 because it has already started to support another police station based on an ad hoc agreement therebetween on a site (the V station 140).

The aforementioned police stations having these factors may be considered unsuitable as alliance partners from the viewpoint of the A station which is a support recipient (a support requesting side), because of the problems of incapability of providing what is needed by the support recipient, and a delay of support provision timing. Hence, in the present embodiment, whether or not each alliance partner candidate has a capacity to provide necessary support (supporter capacity) is estimated with these factors taken into account, and alliance partners are determined based on the estimation results.

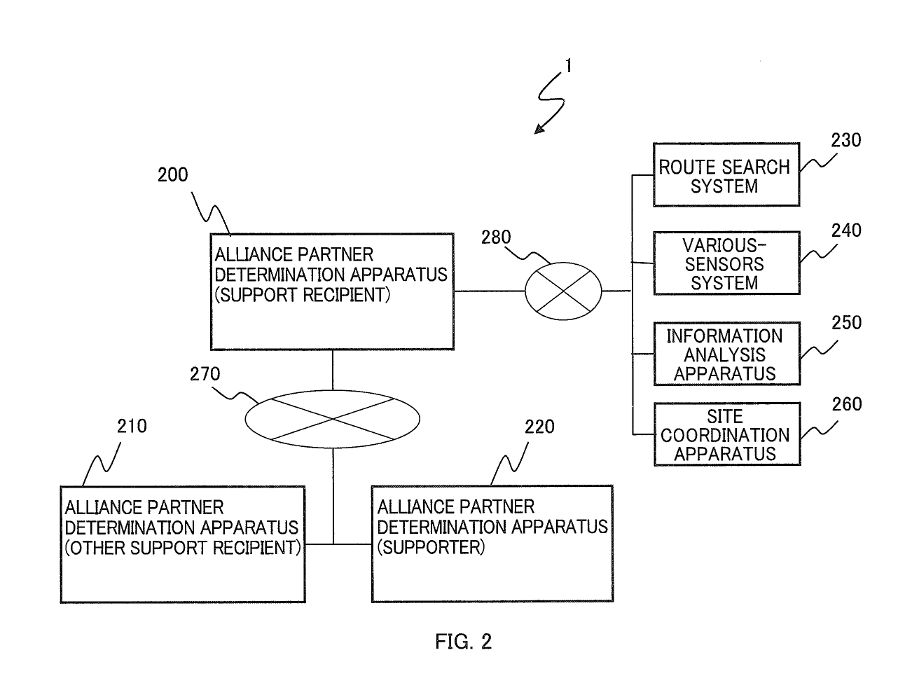

Next, description is provided for a system configured to perform processing of determining an alliance partner in taking into account the obstructive factors for support in alliance partner candidates, which are conceptually exemplified in FIG. 1. FIG. 2 illustrates a system configuration example of an alliance partner determination system 1 for executing main processing in the present embodiment. In the alliance partner determination system 1 in FIG. 2, when organizations need to cope with a certain situation in alliance with each other, an alliance partner determination apparatus 200, which is a support requester, estimates a capacity of each supporter by using other alliance partner determination apparatuses 210, 220 and existing systems.

The alliance partner determination apparatus 200 is a system introduced into a support recipient which desires to receive support, and is coupled via a communication network 280 to a route search system 230, a various-sensors system 240, an information analysis apparatus 250, a site coordination apparatus 260, and the like, which are internal systems used by the support requesting side to estimate the capacities of supporters. As the communication network 280, any communication network may be employed among various networks such as a local area network (LAN), a dedicated line, a wide area network (WAN), a power-line network, a wireless network, a public network, a mobile telephone network, and a satellite communication link.

The route search system 230 is a system configured to perform search based on a given departure location, arrival location and bypass location to find a travel route, a travel time, and a transportation mode to travel from the departure location to the arrival location. Specifically, the route search system 230 is, for example, a computer in which navigation software using global positioning system (GPS) data or the like is installed.

The various-sensors system 240 includes sensors, such as a seismometer and a river water level gauge, configured to detect and measure phenomena related to disasters; information systems of various news media; systems of various information media set up on the Internet; disaster prevention systems owned by disaster prevention-related organizations; traffic monitoring systems to monitor traffic conditions on roads; information systems, such as a social network service system, to provide what is termed as word-of-mouth information; and other systems.

The information analysis apparatus 250 is an apparatus configured to implement functions to analyze data accumulated in the apparatus 250 and data opened to the public by the systems of other organizations, and to estimate the current situation of a disaster-affected area, the progress of the disaster, and an accompanying impact on activities for coping with the disaster. The information analysis apparatus 250 is a computer in which installed is software having functions to analyze text uploaded on SNS sites and web sites of various organizations on the Internet, for example, and to extract items related to a situation such as a disaster.

The site coordination apparatus 260 is an apparatus configured to receive site information from a site where involved parties such as supporters and support recipients on the site set up an ad-hoc cooperation relationship at their discretion as an emergency response regardless of whether a cooperation agreement between their organizations has been signed or not, and to distribute the received site information to other systems. Here, the site information includes information on the organization to which the supporters belong, provided staffs and their attributes, provided relief supplies, and the like. The site adjustment apparatus 260 may be built as, for example, a computer including a database in which site information inputted by on-site leaders and others from any relevant information terminals is accumulated.

The alliance partner determination apparatus 200 is coupled via a communication network 270 to the alliance partner determination apparatus 220 introduced in another organization as a candidate for a supporter, for example, another police station in the present embodiment, and/or the alliance partner determination apparatus 210 introduced in another support recipient to which the supporter may possibly provide support. Since the positions of the supporter and the other support recipient may be possibly exchanged depending on a situation, the alliance partner determination apparatuses 200, 210, 220 illustrated in FIG. 2 have an equivalent configuration as described later. Incidentally, the communication network 280 and the communication network 270 are formed of different networks in the example of FIG. 2, but the two networks 280, 270 may be formed of a single network. As the communication network 270, any communication network may be employed among various networks such as a local area network (LAN), a dedicated line, a wide area network (WAN), a power-line network, a wireless network, a public network, a mobile telephone network, and a satellite communication link.

In addition, in the alliance partner determination system 1 illustrated in FIG. 2, a capacity information distribution apparatus may be also coupled to the communication network 270. When the capacities of a supporter and a support recipient are changed, i.e., are increased or decreased, as a result of a support request and a request acceptance agreed between the organizations, the capacity information distribution apparatus distributes information on the changes in the capacities to the organizations under the system 1. To this end, the capacity information distribution apparatus may be configured to collect, from the alliance partner determination apparatuses 200, 210, 220, information on support capacities possessed in their owner organizations, and distribute the collected information to the alliance partner determination apparatuses 200, 210, 220.

Instead, the capacity information distribution apparatus may be configured to collect only information on whether the support capacity is changed or not from each alliance partner determination apparatus, and promote an alliance partner determination apparatus from which the support capacity change is detected to distribute the support capacity information to the other alliance partner determination apparatuses.

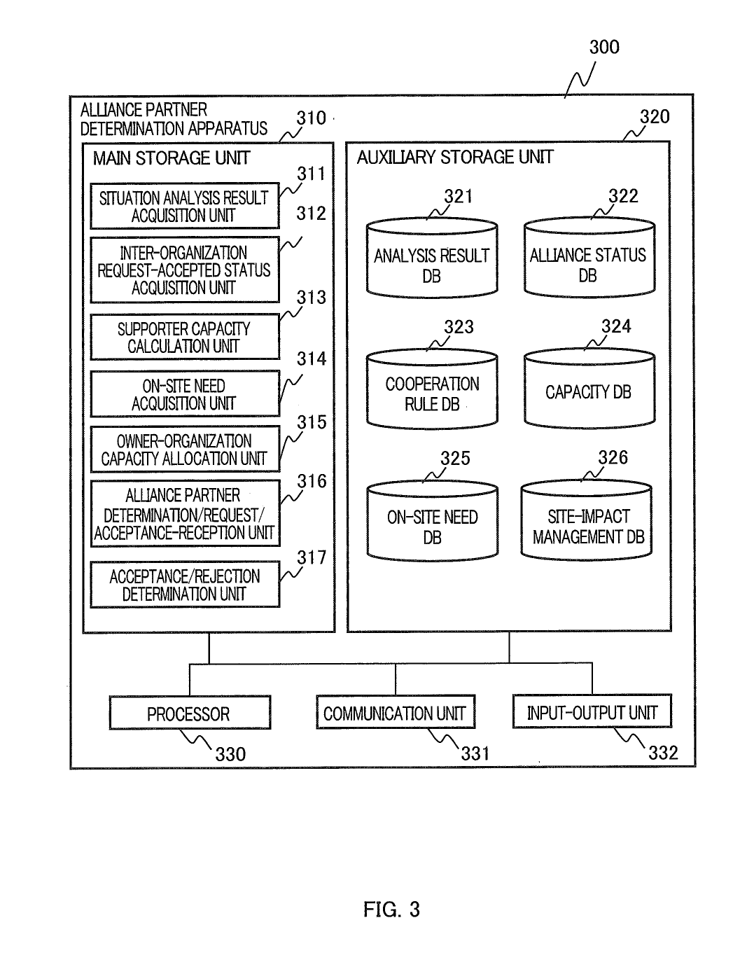

Next, each of the alliance partner determination apparatuses 200, 210, 220 is explained. FIG. 3 illustrates a configuration example of an alliance partner determination apparatus 300 in the present embodiment. As described above, the alliance partner determination apparatuses 200, 210, 220 illustrated in FIG. 2 have the equivalent configuration. Thus, here, sign 300 is collectively assigned to the alliance partner determination apparatuses. In other words, the alliance partner determination apparatus 300 represents implementation examples of the alliance partner determination apparatus 200 as the support recipient, the alliance partner determination apparatus 220 as the supporter, and the alliance partner determination apparatus 210 as the other support recipient.

The alliance partner determination apparatus 300 has a configuration similar to that of a general computer, and includes a processor 330 built as a central processing unit (CPU) or the like, a main storage unit 310 including storage devices such as a random access memory (RAM) and a read only memory (ROM), an auxiliary storage unit 320 including storage devices such as a hard disk drive (HUD) and a solid state drive (SSD), a communication unit 331 which serves as communication interfaces with the communication networks 270, 280, and the like, and includes communication devices such as a network interface card (NIC), and an input-output unit 332 including input devices such as a keyboard, a mouse, and a touch panel, and output devices such as a display monitor and a printer. These elements are communicatively coupled to each other via a bus.

The auxiliary storage unit 320 stores an analysis result database 321, an alliance status database 322, a cooperation rule database 323, a capacity database 324, an on-site need database 325, and a site-impact management database 326. Structure examples of these databases are described later.

A situation analysis result acquisition unit 311, an inter-organization request-accepted status acquisition unit 312, a supporter capacity calculation unit 313, an on-site need acquisition unit 314, an owner-organization capacity allocation unit 315, an alliance partner determination/request/acceptance-reception unit 316, and an acceptance/rejection determination unit 317 are programs stored in advance in the auxiliary storage unit 320, for example. In the following description, as for the alliance partner determination apparatus 300, an expression in which any of the aforementioned parts is described as an actor means that the processor 330 implements functions of the unit by loading the relevant program from the auxiliary storage unit 320 to the main storage unit 310, and then executing the loaded program. The processing details of each of the programs are described later in connection with examples of data processing flows of the alliance partner determination apparatus 300.

In the configuration example of FIG. 3, the alliance partner determination apparatus 300 performs input and output processing alone. Instead, the alliance partner determination apparatus 300 may be coupled to another information terminal such as a smartphone via a communication network, and may input and output data through an input-output unit of the information terminal. As the communication network in this case, any communication network may be employed among various communication networks such as the communication networks 280, 270.

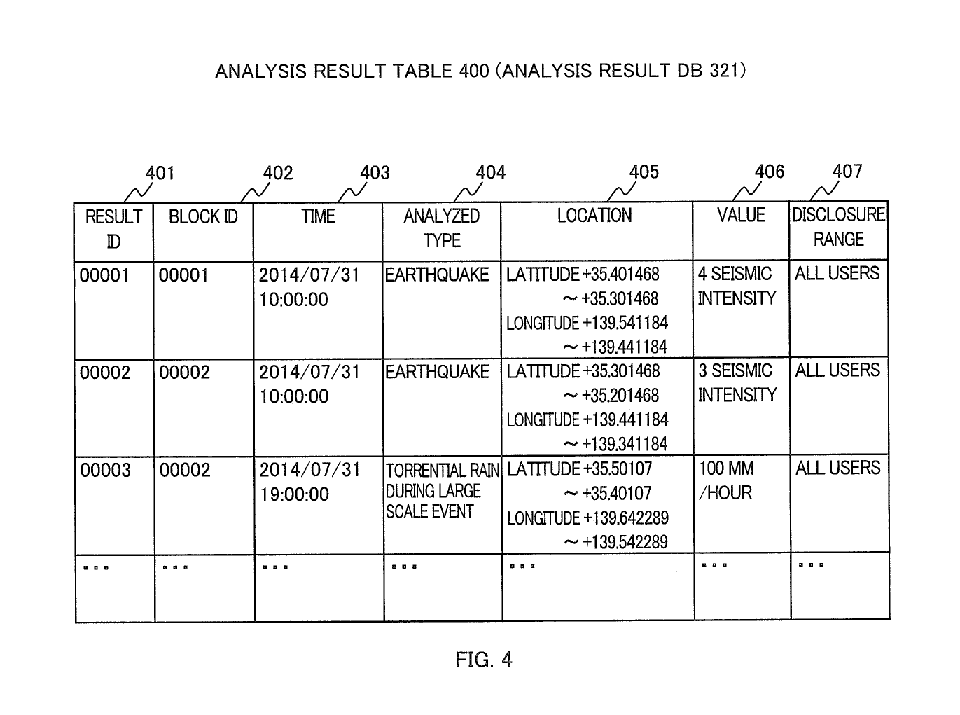

Next, description is provided for the structures of the databases prepared in the alliance partner determination apparatus 300 in FIG. 3. Data stored in these databases are used in the data processing, to be described later, in the alliance partner determination apparatus 300. In the first place, the analysis result database 321 is explained. FIG. 4 presents a structure example of the analysis result database 321. The analysis result database 321 includes an analysis result table 400.

The analysis result table 400 stores an analysis result which is obtained by the information analysis apparatus 250 analyzing information on a situation such as a disaster, and which indicates how each area is affected. The analysis result table 400 includes a result ID 401, a block ID 402, a time 403, an analyzed type 404, a location 405, a value 406, and a disclosure range 407. The result ID 401 is an identifier for uniquely identifying a result of analysis on how an area assigned with the result ID 401 is affected in the occurrence of a certain situation, and is a key for identifying each record. The block ID 402 is an identifier for distinguishing the area from other areas. The time 403 indicates a time when the analysis result is registered or updated in a record. The analyzed type 404 indicates a summary of the analysis result of an occurring situation (for example, an earthquake or a torrential rain during a large scale event). The location 405 indicates a specific coordinate range indicating where an area in the block ID 402 is located. The location of the area is specified by the latitude and longitude in the example of FIG. 4, but may be specified in any way other than that. The value 406 indicates a value of the analysis result on a situation of each record. Examples of the value 406 include a seismic intensity measured in an affected area in the occurrence of an earthquake, a precipitation for the latest one hour during a torrential rain, or the like. The disclosure range 407 indicates information of operators and organizations allowed to access the associated record.

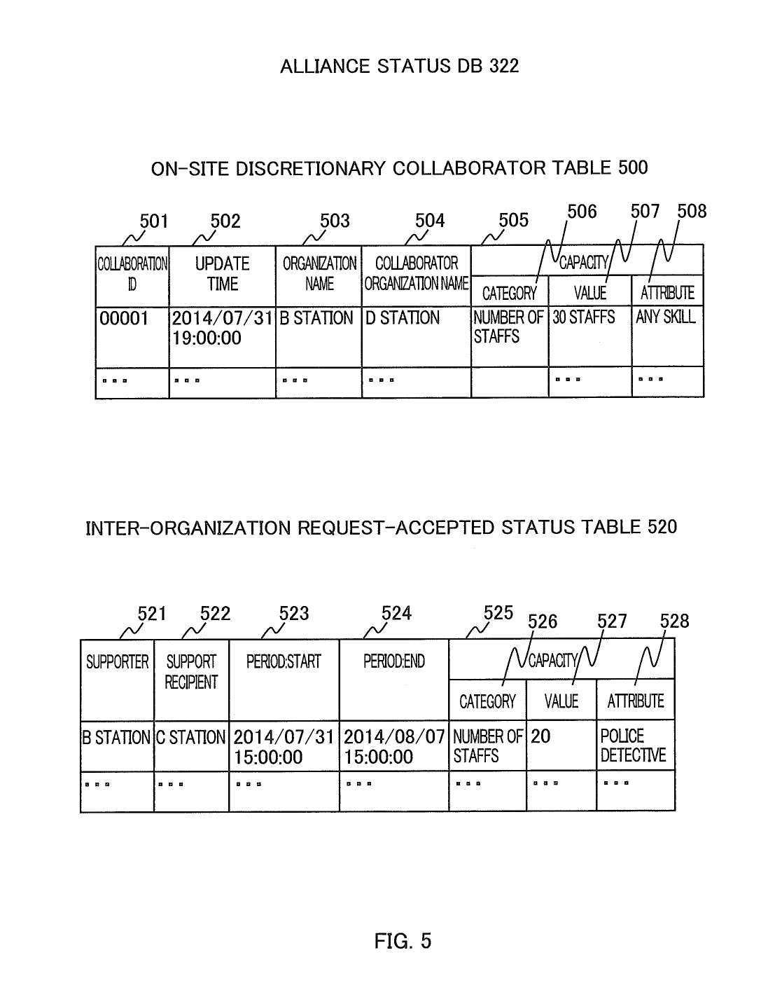

Next, the alliance status database 322 is explained. FIG. 5 presents a structure example of the alliance status database 322. The alliance status database 322 includes an on-site discretionary collaborator table 500 and an inter-organization request-accepted status table 520.

The on-site discretionary collaborator table 500 stores information on other organizations which have already started to collaborate with and support the owner and other organizations at the discretion of on-site staff. The data in the on-site discretionary collaborator table 500 is inputted from the site coordination apparatus 260 in FIG. 2, for example.

The on-site discretionary collaborator table 500 includes a collaboration ID 501, an update time 502, an organization name 503, a collaborator organization name 504, and a capacity 505. The collaboration ID 501 is an identifier for identifying information on a collaboration status with another organization, and is a key for distinguishing each record from other records. The update time 502 indicates a time when the collaboration status is added to or updated in the record. The organization name 503 indicates an organization as a support recipient which receives support. The collaborator organization name 504 indicates an organization as a supporter which is providing support on the site. The capacity 505 indicates a capacity being provided by the organization identified by the collaborator organization name 504. The capacity 505 includes a category 506, a value 507, and an attribute 508. The category 506 is an item indicating a category of the capacity, and indicates a unit such, for example, as the number of staffs engaged in the support, a quantity of provided materials/equipment such as makeshift beds, or a quantity of food stuffs. The value 507 indicates the number or quantity of staffs or materials provided under the name of the associated category 506. The attribute 508 indicates a group which is a sub-category of the category 506. For example, if the category 506 is the number of staffs, the attribute 508 indicates that the staffs are persons skilled as, for example, police detectives, traffic officers, security polices, or the like.

The inter-organization request-accepted status table 520 stores a status of a request and an acceptance for support agreed by different organizations. The data of the inter-organization request-accepted status table 520 may be built by acquiring alliance partner determination results in the alliance partner determination apparatuses 300 of the other organizations. The inter-organization request-accepted status table 520 includes a supporter 521, a support recipient 522, a period:start 523, a period:end 524, and a capacity 525. The supporter 521, the support recipient 522, the period:start 523, and the period:end 524 are a key for identifying information indicating when and which organization promises to support which organization. The supporter 521 is an identifier for identifying an organization which supports another organization. The support recipient 522 is an identifier for identifying an organization which receives support from another organization (is supported). The period:start 523 indicates a starting time of the support. The period:end 524 indicates an ending time of the support. The capacity 525 includes a category 526, a value 527, and an attribute 528 as in the capacity 505. As is the case with the category 506, the category 526 is an item indicating a category of the capacity, and indicates a unit such, for example, as the number of staffs engaged in the support, a quantity of provided materials/equipment such as makeshift beds, or a quantity of food stuffs. As is the case with the value 507, the value 527 indicates the number or quantity of staffs, materials, or the like provided under the name of the associated category 526. As is the case with the attribute 508, the attribute 528 indicates a group which is a sub-category of the category 526. For example, if the category 526 is the number of staffs, the attribute 528 indicates that the staffs are persons skilled as, for example, police detectives, traffic officers, security polices, or the like.

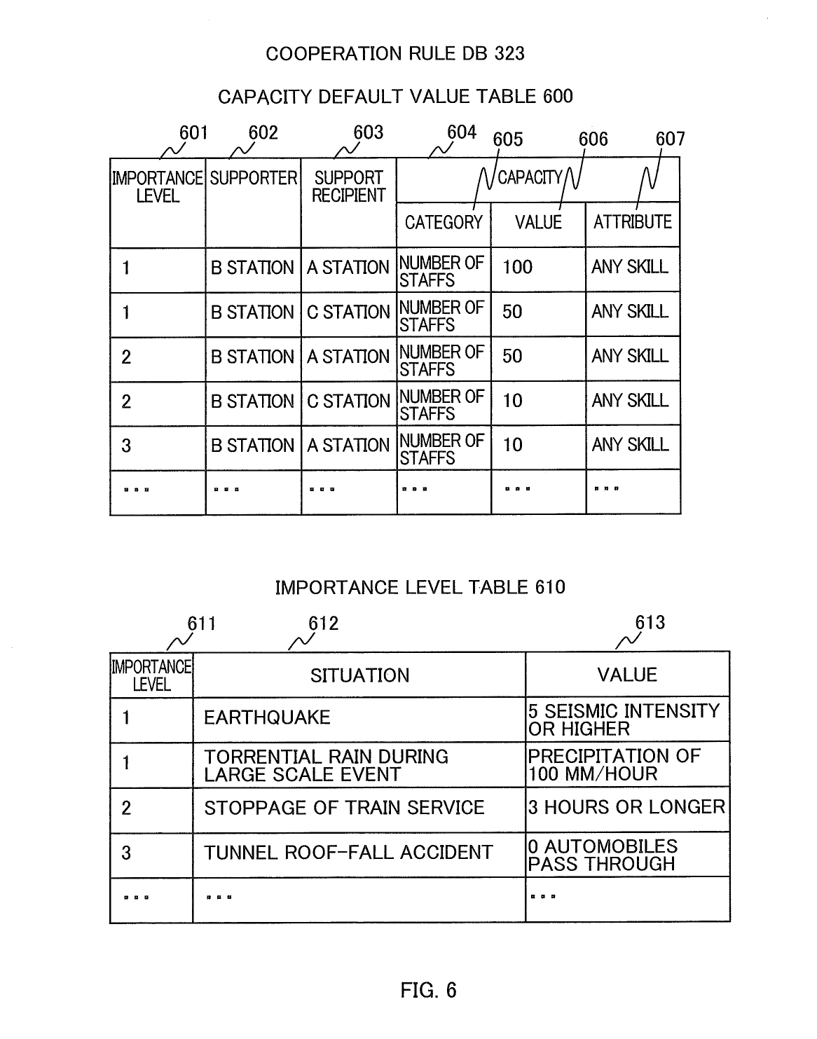

Next, the cooperation rule database 323 is explained. FIG. 6 presents a structure example of the cooperation rule database 323. The cooperation rule database 323 includes a capacity default value table 600 and an importance level table 610. In the capacity default value table 600 and the importance level table 610, predetermined values and data are recorded in advance before the operation of the system 1 starts.

The capacity default value table 600 stores information on agreements each concluded in advance between organizations and defining how much capacity each party will provide to support the other party in the occurrence of a situation such as a disaster. Such support agreements cover a wide range of agreements such as one concluded between a local government and a food company and defining rules for offering food stuffs in case of a disaster, for example. The capacity default value table 600 includes an importance level 601, a supporter 602, a support recipient 603, and a capacity 604. The importance level 601, the supporter 602, and the support recipient 603 are a key for identifying information indicating which organization will support which organization in what situation. The importance level 601 is a value indicating an importance of an impact caused by a situation supposed to occur. Specific values of the importance level 601 are defined in the importance level table 610 to be described later. The supporter 602 is an identifier for identifying an organization which will support another organization. The support recipient 603 is an identifier for identifying an organization which will receive support from (is supported by) another organization. The capacity 604 indicates default values of a support capacity that the supporter 602 will provide to the support recipient 603 in the occurrence of a situation specified by the importance level 601. As is the case with the capacity 505 in FIG. 5, the capacity 604 includes a category 605, a value 606, and an attribute 607. As is the case with the category 506, the category 605 is an item indicating a category of a capacity, and indicates a unit such, for example, as the number of staffs engaged in the support, a quantity of provided materials/equipment such as makeshift beds, or a quantity of food stuffs. As is the case with the value 507, the value 606 indicates the number or quantity of staffs, materials, or the like provided under the name of the associated category 605. As is the case with the attribute 508, the attribute 607 indicates a group which is a sub-category of the category 605. For example, if the category 605 is the number of staffs, the attribute 607 indicates that the staffs are persons skilled as, for example, police detectives, traffic officers, security polices, or the like.

The importance level table 610 stores information defining an importance of an impact of a situation supposed to occur. The importance level table 610 includes an importance level 611, a situation 612, and a value 613. The importance level 611, the situation 612, and the value 613 are a key for identifying information on the importance level of a situation. The importance level depends on what situation occurs and how much impact is caused by the situation, or for example, depends on a seismic intensity in case of occurrence of an earthquake. The importance level 611 is a value indicating an importance given by the impact of a situation supposed to occur. The situation 612 indicates a summary of an analysis result corresponding to that in the analyzed type 404 in the analysis result table 400 in FIG. 4 (for example, an earthquake, or a torrential rain during a large scale event). The value 613 indicates a magnitude of an impact of the situation 612. Here, the value 613 may be expressed in the form of AND conditions or OR conditions of multiple values.

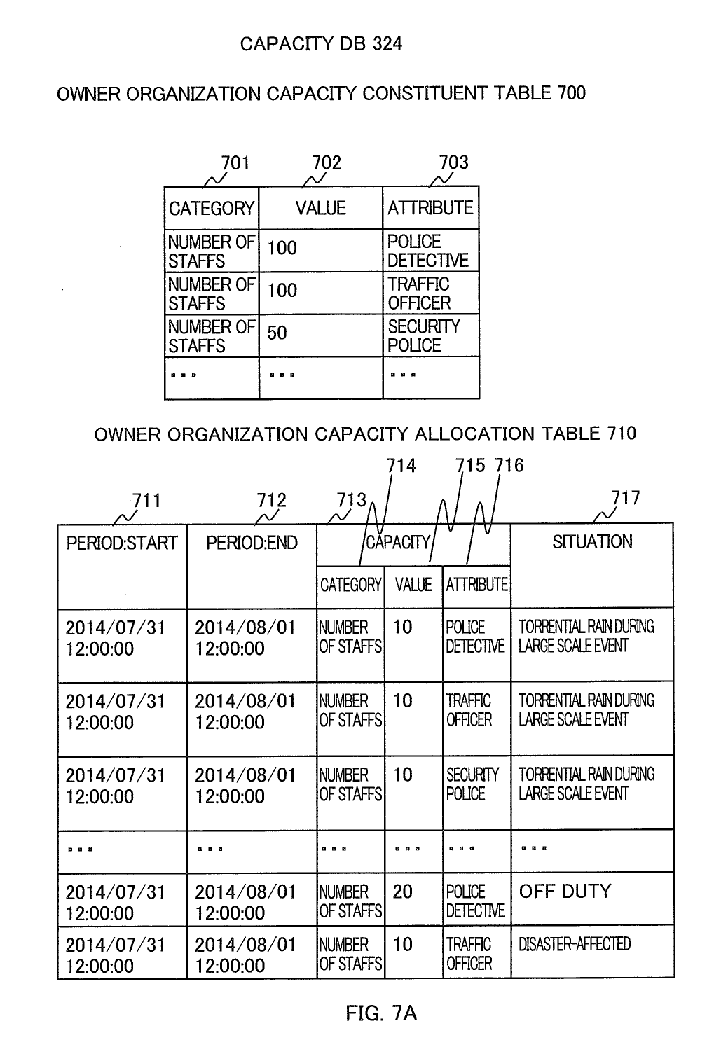

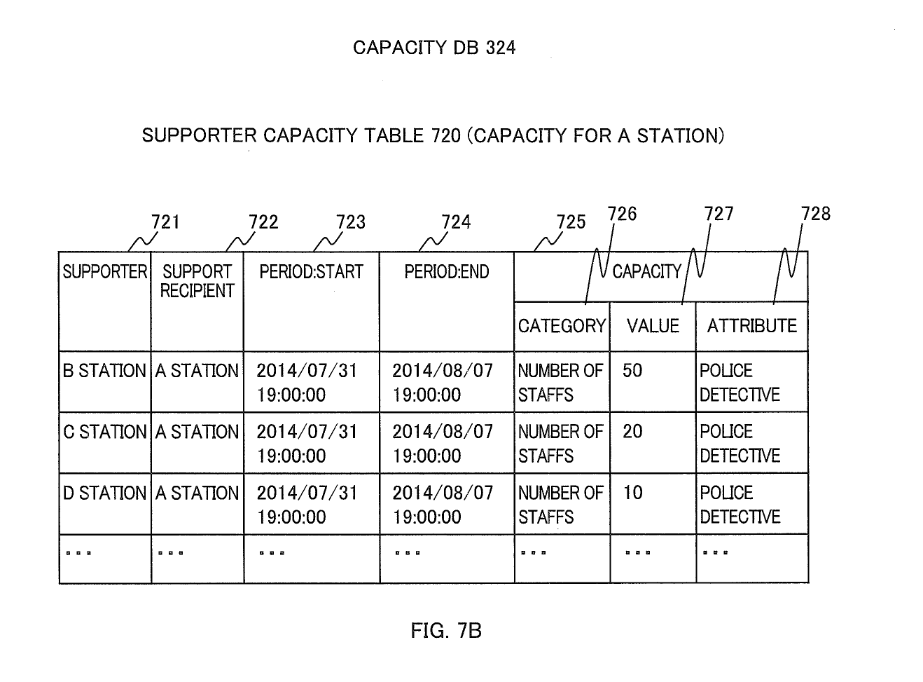

Next, the capacity database 324 is explained. FIG. 7A and FIG. 7B present a structure example of the capacity database 324. The capacity database 324 includes an owner organization capacity constituent table 700, an owner organization capacity allocation table 710, and a supporter capacity table 720.

In the owner organization capacity constituent table 700, registered in advance is data of the support capacity of an owner organization (a certain organization, for example, the A station in FIG. 1) where the alliance partner determination apparatus 300 holding this table 700 is installed. The owner organization capacity constituent table 700 includes a category 701, a value 702, and an attribute 703. The category 701 is an item for indicating a category of the capacity, and indicates a unit such, for example, as the number of staffs engaged in the support, a quantity of provided materials/equipment such as makeshift beds, or a quantity of food stuffs. The value 702 indicates the number or quantity of staffs, materials, or the like provided under the name of the associated category 701. The attribute 703 indicates a group which is a sub-category of the category 701. For example, if the category 701 is the number of staffs, the attribute 703 indicates that the staffs are persons skilled as, for example, police detectives, traffic officers, security polices, or the like.

The owner organization capacity allocation table 710 stores allocation information indicating to what situation to allocate the capacity of the owner organization where the alliance partner determination apparatus 300. Data of the owner organization capacity allocation table 710 is updated every time the state of allocation of the support capacity to another organization is changed. The owner organization capacity allocation table 710 includes a period:start 711, a period:end 712, a capacity 713, and a situation 717. The period:start 711, the period:end 712, and the capacity 713 are a key for identifying information on when and which capacity of the owner organization will be dedicated to what situation. The period: start 711 indicates a starting time of the support. The period:end 712 indicates an ending time of the support. The capacity 713 includes a category 714, a value 715, and an attribute 716. The category 714, the value 715, and the attribute 716 are the same items as the category 701, the value 702, and the attribute 703 in the owner organization capacity constituent table 700, respectively. The situation 717 indicates a summary of a situation analyzed in the analyzed type 404 in the analysis result table 400 in FIG. 4 (for example, an earthquake, a torrential rain during a large scale event, or others).

The supporter capacity table 720 stores estimated values of a capacity estimated by the owner organization as a capacity that can be provided for support by another organization. Assuming that the A station in FIG. 1 is an owner station, the supporter capacity table 720 in the example of FIG. 7B stores estimated values of capacities that other organizations can provide for support to the A station. The supporter capacity table 720 includes a supporter 721, a support recipient 722, a period:start 723, a period:end 724, and a capacity 725. The supporter 721, the support recipient 722, the period:start 723, and the period:end 724 are a key for identifying information indicating an estimation as to when and which organization can support which organization. The supporter 721 is an identifier for identifying an organization which may support another organization. The support recipient 722 is an identifier for identifying an organization which may receive support from (can be supported by) another organization. Here, an owner organization is registered in the support recipient 722, that is, the A station is registered in the example of FIG. 7B as described above. The period:start 723 indicates a starting time of the support. The period:end 724 indicates an ending time of the support . The capacity 725 includes a category 726, a value 727, and an attribute 728, which indicate the same things as those of the category 701, the value 702, and the attribute 703 in the owner organization capacity constituent table 700, respectively.

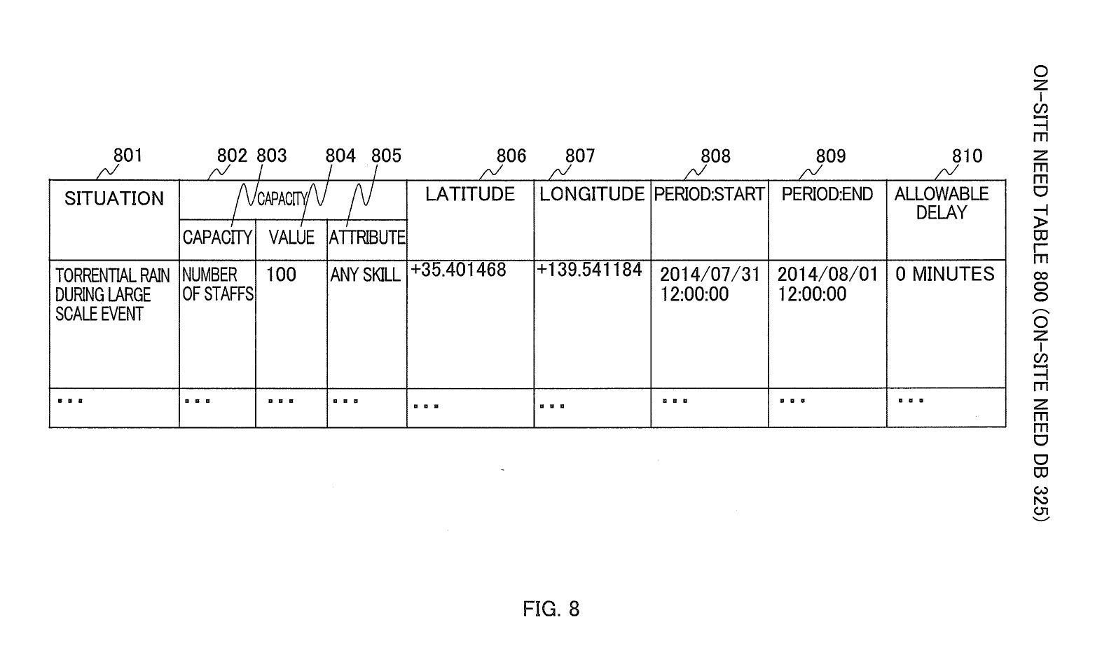

Next, the on-site need database 325 is explained. FIG. 8 presents a structure example of the on-site need database 325. The on-site need database 325 includes an on-site need table 800.

The on-site need table 800 stores information on on-site needs to compensate for a shortage of the capacity on a site. The information on the on-site needs may be acquired from, for example, the site coordination apparatus 260 in FIG. 2. The on-site need table 800 includes a situation 801, a capacity 802, a latitude 806, a longitude 807, a period:start 808, a period:end 809, and an allowable delay 810. The situation 801, the capacity 802, the latitude 806, the longitude 807, the period:start 808, and the period:end 809 are a key for identifying information on a need to compensate for a shortage of the capacity on a site. The situation 801 indicates a summary of a situation recorded corresponding to the analyzed type 404 of the analysis result table 400 exemplified in FIG. 4 (for example, an earthquake, a torrential rain during a large scale event, or the like) . The capacity 802 includes a category 803, a value 804, and an attribute 805. The category 803 is an item indicating a category of a needed capacity, and indicates a unit such, for example, as the number of staffs needed for the support, a quantity of materials/equipment such as makeshift beds needed to be provided, or a quantity of food stuffs needed to be provided. The value 804 indicates the number or quantity of staffs, materials, or the like needed to be provided under the name of the associated category 803. The attribute 805 indicates a group which is a sub-category of the category 803. For example, if the category 803 is the number of staffs, the attribute 805 indicates that the staffs are persons skilled as, for example, police detectives, traffic officers, security polices, or the like. The period:start 808 indicates a time at which a needed support is desired to start. The period:end 809 indicates a time at which a needed support is desired to complete. The allowable delay 810 indicates an upper limit of a delay time allowable for the period:start 808.

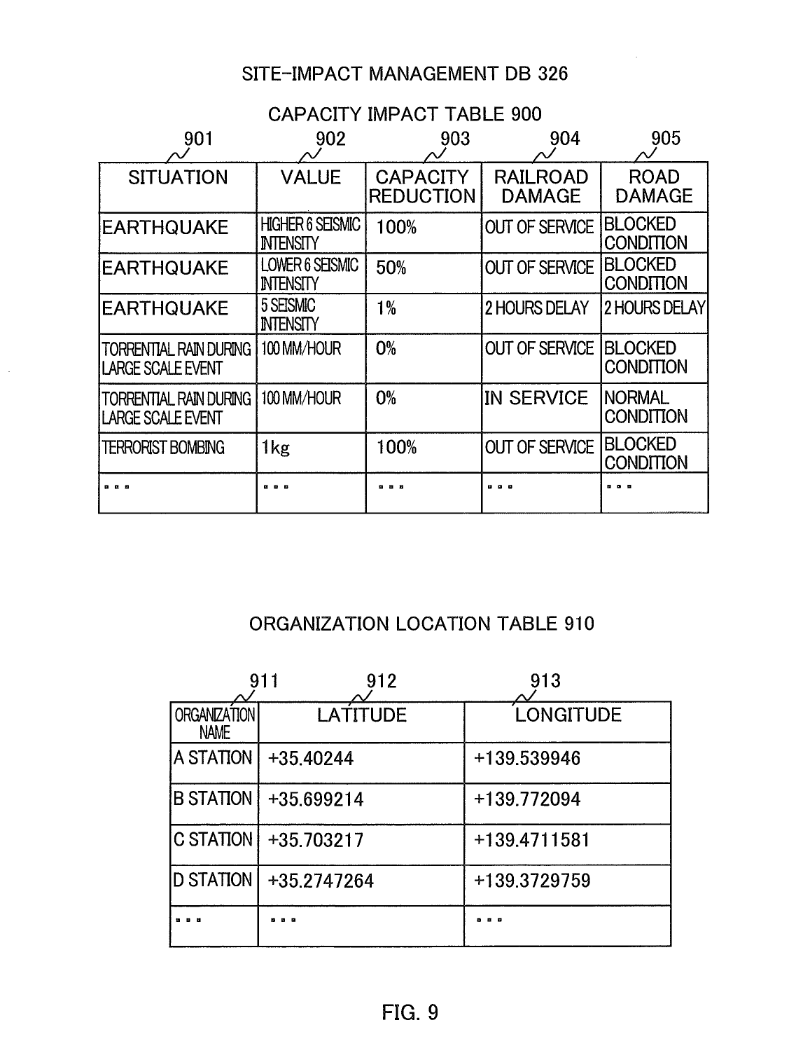

Next, the site-impact management database 326 is explained. FIG. 9 presents a structure example of the site-impact management database 326. The site-impact management database 326 includes a capacity impact table 900 and an organization location table 910. The capacity impact table 900 stores in advance basic information for calculating what impact a certain situation, if it occurs, may make on the capacity of an organization.

The capacity impact table 900 includes a situation 901, a value 902, a capacity reduction 903, a railroad damage 904, and a road damage 905. The situation 901 and the value 902 are a key for identifying information indicating what impact a certain situation, if it occurs, may make on the capacity of the organization, railroads, and roads. The situation 901 indicates a summary of a situation supposed to occur (for example, an earthquake, a torrential rain during a large scale event, or the like). The value 902 indicates an objective degree of the magnitude of the situation 901. If the associated situation 901 is an earthquake, for example, “lower 6 seismic intensity on the Japanese intensity scale of 7” or the like is recorded in the value 902. The capacity reduction 903 indicates how much the associated situation 901 reduces the capacity of the organization. In the example of FIG. 9, the capacity reduction 903 is expressed in the unit of percentage, and “100%” means that there is no support capacity. The railroad damage 904 and the road damage 905 indicate how much the situation recorded in association with them damages railroads and roads.

The organization location table 910 stores in advance information indicating a location of each organization. The organization location table 910 includes an organization name 911, a latitude 912, and a longitude 913. The organization name 911 is a key.

The organization name 911 indicates the name of an organization. The latitude 912 and the longitude 913 indicate latitude information and longitude information of the location of the organization specified by the associated organization name 911.

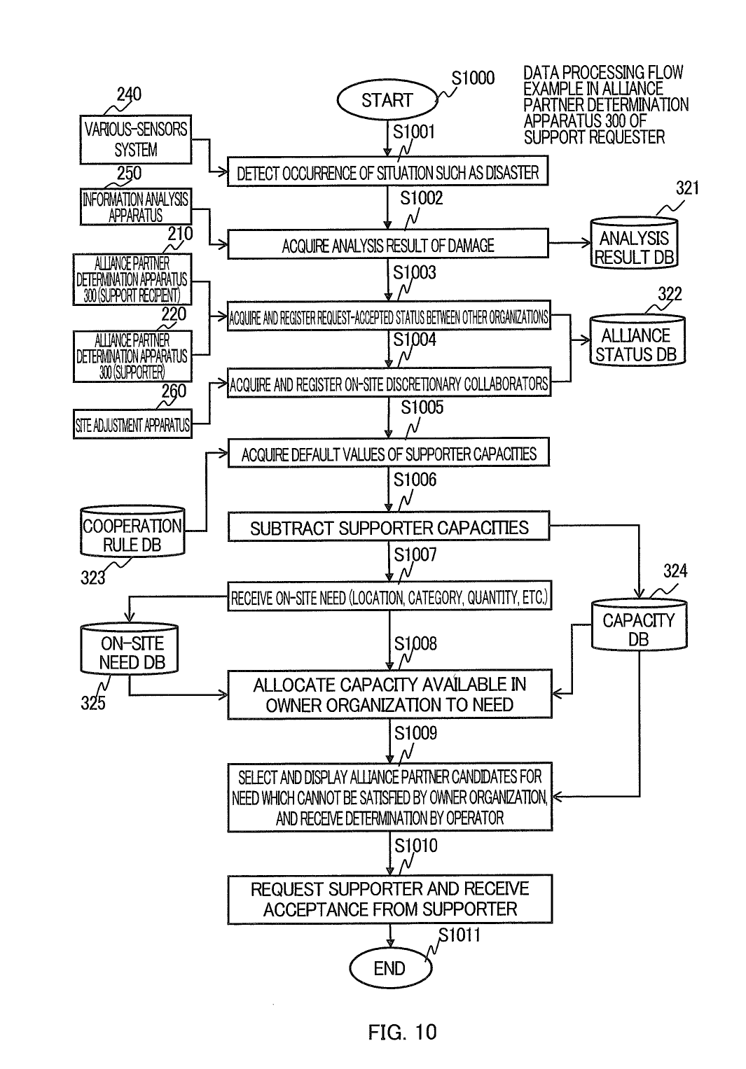

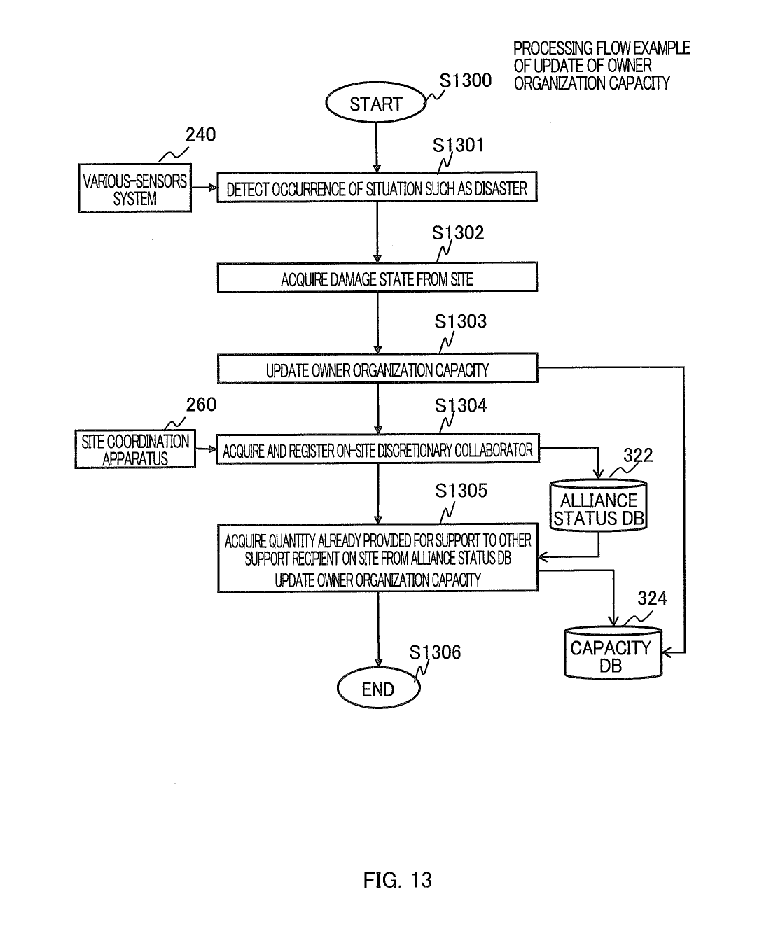

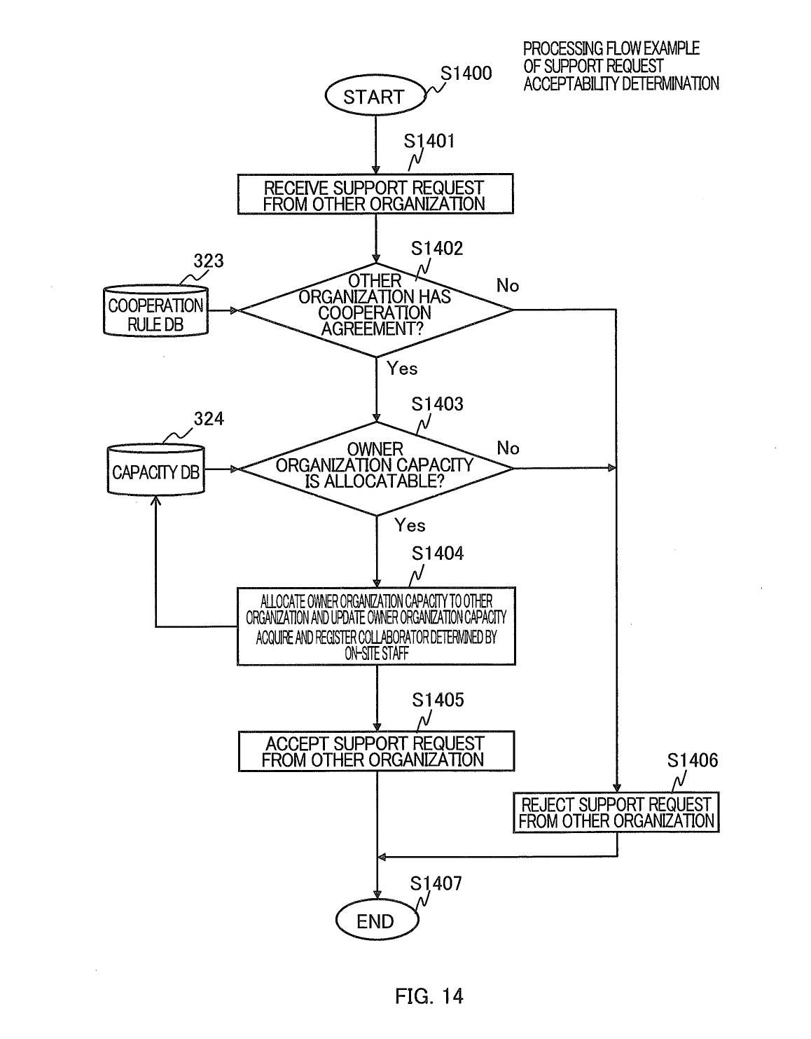

Hereinafter, description is provided for data processing executed by the alliance partner determination apparatus 300 in the present embodiment. FIG. 10 presents an example of a data processing flow to executed by the alliance partner determination apparatus 200 installed in an organization (support recipient) desiring to make support requests, in order to detect the occurrence of a situation such as a disaster, to calculate the supporter capacities of other organizations, select and display, as alliance partner candidates, supporters having the capacities meeting needs from the site, and to receive a determination made by an operator. Note that the functional blocks and the databases in the diagrams of the processing flows described below indicate those to and from which execution entities send or receive data in processing steps. In addition, alliance partner determination processing in FIG. 10 is executed in parallel with owner organization capacity update processing in FIG. 13 and alliance partner acceptability determination processing in FIG. 14 which will be described later.

In the first place, the processor 330 in the alliance partner determination apparatus 200 of the support recipient starts the processing flow for alliance partner determination in S1000, and the situation analysis result acquisition unit 311 acquires an alert indicating detection of the occurrence of a situation from the various-sensors system 240 via the communication unit 331 in S1001. In the present embodiment, it is assumed that the occurrence of a torrential rain during a large scale event is detected as illustrated in FIG. 1.

In S1002, the situation analysis result acquisition unit 311 acquires a damage analysis result from the information analysis apparatus 250 via the communication unit 331. The damage analysis result indicates an impact range of the occurrence of the situation analyzed and determined by the information analysis apparatus 250. The situation analysis result acquisition unit 311 stores the analysis result in the analysis result table 400 of the analysis result database 321.

In S1003, the inter-organization request-accepted status acquisition unit 312 receives inter-organization alliance request-acceptance information via the communication unit 331 from the alliance partner determination apparatus 220 of a supporter candidate, and the alliance partner determination apparatus 210 of the other organization which may possibly receive support from the supporter candidate. The inter-organization request-accepted status acquisition unit 312 stores the acquired inter-organization alliance request-acceptance information in the inter-organization request-accepted status table 520 of the alliance status database 322.

In S1004, the inter-organization request-accepted status acquisition unit 312 acquires, via the communication unit 331 from the site coordination apparatus 260, information on another organization which has already started to collaborate and provide support at the discretion of the on-site staff, and stores the acquired information in the on-site discretionary collaborator table 500 of the alliance status database 322.

In S1005, the supporter capacity calculation unit 313 acquires, from the capacity default value table 600 of the cooperation rule database 323, the default values of the supporter capacity expected to be received as support from each of other organizations in the occurrence of the situation. To acquire the default values, the supporter capacity calculation unit 313 firstly acquires the analyzed type 404, the location 405, and the value 406 of the current situation from the analysis result table 400. Then, the supporter capacity calculation unit 313 finds out an important facility under the jurisdiction of the own station within the area indicated by the location 405. In this step, an important facility may be found from among important facilities registered as organizations in the organization location table 910 of the site-impact management database 326. From the importance level table 610 in the cooperation rule database 323, the supporter capacity calculation unit 313 acquires the importance level 611 of each record which has the situation 612 and the value 613 matching the analyzed type 404 and the value 406. In addition, from the capacity default value table 600, the supporter capacity calculation unit 313 acquires the supporter 602 and the capacity 604 of each record in which the importance level 601 matches the acquired importance level 611, and the support recipient 603 specifies the own station. Then, the supporter capacity calculation unit 313 sets the acquired capacity 604 as the default values of the supporter capacity of the acquired supporter 602.

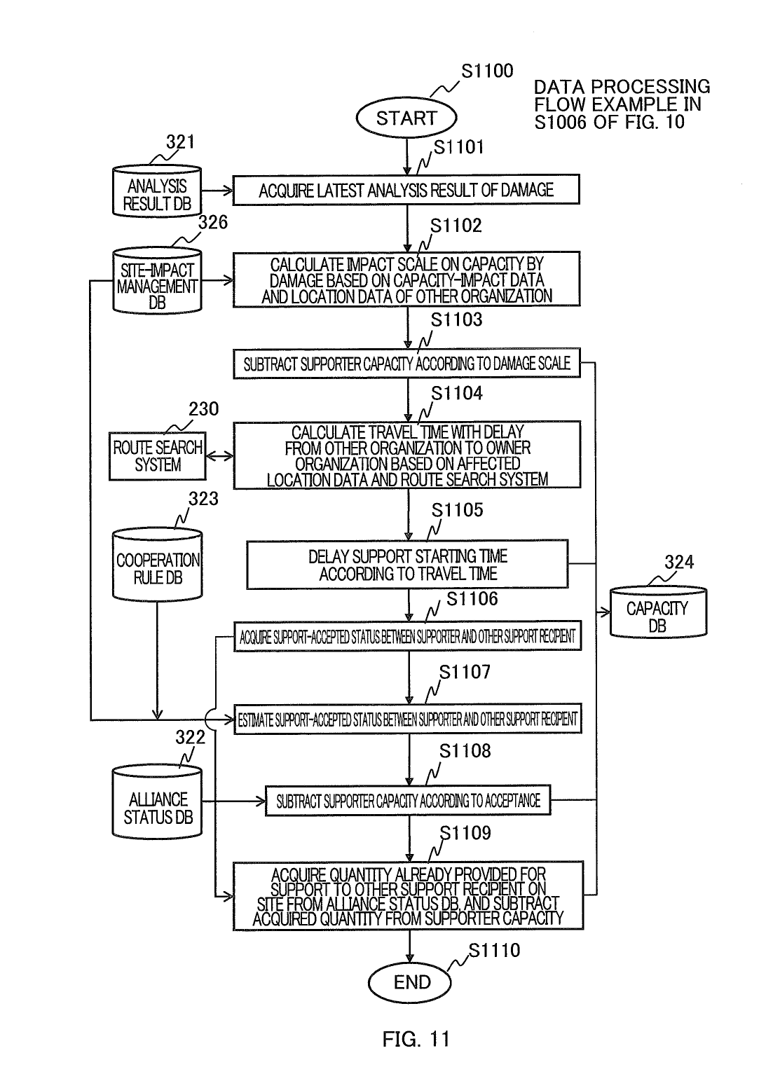

In S1006, the supporter capacity calculation unit 313 performs subtraction from the default values of the supporter capacity acquired in S1005, based on the factors described in FIG. 1 (When: the arrival at a support site is delayed due to a traffic network jam; Where: a station, located in an area affected by the same situation, is also now taking the actions coping with the situation and cannot allocate its own capacity; Who: a station has not signed a support agreement in advance; What: a station does not possess the attribute of a needed capacity; Why: a station cannot allocate its own capacity because the station has already accepted a support request from another organization; and How: a station cannot allocate its own capacity because the station has already started to support another station based on an ad hoc agreement therebetween on the site. Then, the supporter capacity calculation unit 313 stores the supporter capacity estimated values thus obtained in the supporter capacity table 720 of the capacity database 324. The processing details in S1006 are described later in reference to FIG. 11.

In S1007, from the site coordination apparatus 260, the on-site need acquisition unit 314 acquires information indicating which site, how many, when and what capacity needs to be provided to, and having been inputted to the site coordination apparatus 260 through the input-output unit 332 by a working staff on the site (a police man working on the site in this embodiment) or an operator informed of the above kinds of information by the working staff on the site. The on-site need acquisition unit 314 stores the acquired information in the on-site need table 800 of the on-site need database 325.

In S1008, the owner-organization capacity allocation unit 315 allocates the owner organization capacity allocatable by the owner organization itself to the on-site need stored in the on-site need table 800 in S1007. The allocation processing includes allocating the capacity of the owner organization to the on-site need by: searching the owner organization capacity allocation table 710 for a record having the capacity 713 matching the capacity 802 in the on-site need table 800, having the period:start 711 and the period:end 712 whose period covers a period specified by the period:start 808 and the period:end 809, and having “off duty” or “on regular duty” in the situation 717; and overwriting the searched-out record in such a way that the situation 717 is overwritten with the situation 801, the period:start 711 is overwritten with the period:start 808, and the period:end 712 is overwritten with period:end 809.

Note that a travel time required to travel to a location specified by the latitude 806 and the longitude 807 in the on-site need table 800 may be acquired by using the route search system 230, and then whether or not the period in which the owner organization capacity is allocatable covers the period required for the on-site need may be determined based on the period:start 808 for the owner organization capacity moved ahead with the travel time taken into account.

Moreover, in the present embodiment, a given table is used as the owner organization capacity allocation table 710 in the initial stage. Instead, “off duty” and “on regular duty” of the capacity of the owner organization may be scheduled based on the category 701, the value 702, and the attribute 703 by using the owner organization capacity constituent table 700, and the scheduling data thus determined may be stored in the owner organization capacity allocation table 710.

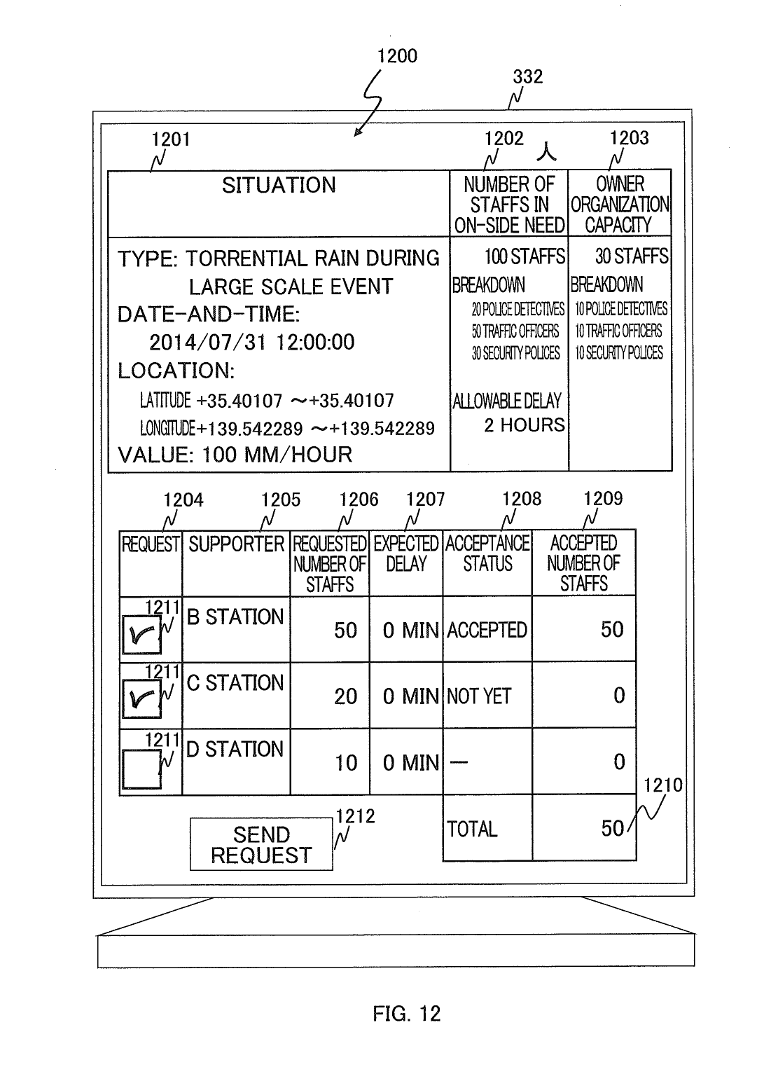

In S1009, for an on-site need which cannot be satisfied by the capacity of the owner organization allocated in S1008, the alliance partner determination/request/acceptance-reception unit 316 determines alliance partner candidates based on the supporter capacity table 720 of the capacity database 324 in which the supporter capacity estimated values are stored in S1006, and displays the determined alliance partner candidates on the input-output unit 332. The display content is described later in reference to FIG. 12. In the determination and display of the alliance partner candidates, the supporter capacity table 720 of the capacity database 324 is searched for records having the owner organization in the support recipient 722, and having the period:start 723 and the period:end 724 whose period covers the period specified by the period:start 808 and the period:end 809 requested for the site need, and a certain number of records among the searched-out records may be determined and displayed in a descending order of the value 727 of the capacity 725. The alliance partner determination apparatus 200 receives a determination made by an operator based on the displayed screen.

Note that the order of determination and display of alliance partner candidates on the input-output unit 332 may be such an ascending order of distance from the own organization that a certain number of supporters 721 closest to the owner organization may be extracted, determined and displayed from among the searched-out records. In this case, the distance from the owner organization may be calculated based on the organization location table 910. Instead, a priority order may be determined in advance among other organizations as supporter candidates, and alliance partner candidates may be determined and displayed in an order determined according to the priority order.

In S1010, via the communication unit 331, the alliance partner determination/request/acceptance-reception unit 316 makes a support request to each supporter determined by the operator in S1009, and receives an acceptance result from the supporter. The request includes items of a capacity (category, value, attribute) and a period (start, end). In this case, an acceptance result does not always indicate an acceptance to provide all the capacity specified by the exactly requested values, and hence the alliance partner determination/request/acceptance-reception unit 316 displays the acceptance result on the screen (described later in FIG. 12), and receives an operation by an operator on a case-by-case basis.

In S1011, the processor 330 terminates the alliance partner determination processing flow.

According to the alliance partner determination processing flow described above, an organization intending to make support requests can accurately estimate the support capacities possessed by other organizations as supporter candidates, select other organizations that can compensate for a shortage of the capacity of the owner organization, and issue support requests to the other organizations thus selected. This may effectively prevent a congestion of the communication network from occurring due to indiscriminate transmission of support requests to a large number of other organizations. In addition, the owner organization does not have to wait for a reply to a support request from an organization having no support capacity, and therefore may be prevented from unnecessarily delaying taking actions coping with a situation.

Hereinafter, description is provided for the supporter capacity subtraction processing (S1006) in the alliance partner determination processing flow in FIG. 10. FIG. 11 is a diagram presenting a detailed processing flow of the supporter capacity subtraction in the processing S1006 which is a part of the processing in the foregoing processing flow in FIG. 10. In the present embodiment, the processing S1006 is executed by the supporter capacity calculation unit 313 in the alliance partner determination apparatus 300.

Subsequent to the processing S1005 in FIG. 10, the supporter capacity calculation unit 313 starts the supporter capacity subtraction processing flow in S1100. In S1101, the supporter capacity calculation unit 313 acquires the latest analysis result of the damage from the analysis result table 400 of the analysis result database 321.

Then, in S1102, the supporter capacity calculation unit 313 acquires the analyzed type 404, the location 405, and the value 406 from a record having a current time in the time 403 in the analysis result table 400, searches the capacity impact table 900 for a record which has the situation 901 and the value 902 matching the analyzed type 404 and the value 406, and acquires data in the capacity reduction 903, the railroad damage 904, and the road damage 905 from the searched-out record. Then, in order to calculate the damage scale of the capacities of organizations located within the area specified by the location 405, the supporter capacity calculation unit 313 searches the organization location table 910 in the site-impact management database 326 by using the latitude 912 and the longitude 913 recorded therein to find each record having the location within the area specified in the location 405, and thereby obtains the organization name 911.

Next, in S1103, the supporter capacity calculation unit 313 subtracts a supporter capacity reduction volume from the supporter capacity of the organization specified by the organization name 911 acquired in S1102, based on the capacity reduction 903 acquired in S1102. Specifically, the supporter capacity calculation unit 313 searches the supporter capacity table 720 of the capacity database 324 to find a record in which the supporter 721 matches the acquired organization name 911 and the support recipient 722 matches the owner organization, and overwrites the value 727 of the capacity 725 in the found record with a value obtained by subtracting the supporter capacity reduction volume from the value 727.

In S1104, the supporter capacity calculation unit 313 calls the route search system 230 via the communication unit 331, and searches for a way of traveling from the location specified by the latitude 912 and the longitude 913 of the organization name 911 searched out in the S1102 to the location specified by the latitude 806 and the longitude 807 indicating a location having a support need in the on-site need database 325. A search result obtained by the route search system 230 includes a travel route, a travel time, and a transportation mode. The supporter capacity calculation unit 313 determines whether the searched-out travel route passes through the location 405 acquired in S1102. If determining the travel route as passing through the location 405, the supporter capacity calculation unit 313 refers to the railroad damage 904 acquired in S1102 when determining the transportation mode in that case as transportation by railways, or refers to the road damage 905 acquired in S1102 when determining the transportation mode as transportation by automobile/on foot. If a “delay” or “stoppage” occurs in the transportation mode, the traveling way avoiding the acquired location 405 is searched for again by using the route search system 230, and the travel route, the travel time, and the transportation mode are obtained as a search result. The supporter capacity calculation unit 313 calculates the shortest travel time by iterating the above processing, and obtains a delay time for traveling to the support needing location by calculating a difference of the shortest travel time from the normal travel time which is obtained as the first search result.

Then, in S1105, the supporter capacity calculation unit 313 updates the supporter capacity table 720 of the capacity database 324 according to the travel time calculated in S1104. Specifically, in the record in which the supporter 721 matches the acquired organization name 911 and the support recipient 722 matches the owner organization, the supporter capacity calculation unit 313 overwrites the data in the period:start 723 with a time obtained by adding the travel time to the current time.

In S1106, the supporter capacity calculation unit 313 acquires inter-organization support-accepted statuses from the inter-organization request-accepted status table 520 of the alliance status database 322.

If a pair of a supporter and a support recipient specified by the importance level 601 is present among pairs of the supporter 602 and the support recipient 603 recorded in the capacity default value table 600 of the cooperation rule database 323, but is not present among pairs of the supporter 521 and the support recipient 522 of the inter-organization request-accepted status table 520 of the alliance status database 322, the supporter capacity calculation unit 313 estimates a damage scale of the support recipient to estimate the support request-accepted status of the pair in S1107. Specifically, the supporter capacity calculation unit 313 searches the organization location table 910 for the latitude 912 and the longitude 913 associated with the organization name 911 of the support recipient matching the support recipient 603, acquires the capacity reduction 903 at that location to estimate the capacity reduction of the support recipient, and estimates that the support recipient 603 in the capacity default value table 600 requests the supporter 602 to provide support of the capacity 604 with such a value 606 that the support capacity can compensate for the capacity reduction.

Thereafter, based on the inter-organization support-accepted statuses acquired in S1106 and the estimated information on the inter-organization support-accepted status acquired in S1107, the supporter capacity calculation unit 313 subtracts the value of the capacity in each of the support-accepted statuses from the value 727 of the capacity 725 in the corresponding record recorded in the supporter capacity table 720 of the capacity database 324, and then overwrites the value 727 with the obtained value in S1108.

In S1109, from the on-site discretionary collaborator table 500 of the alliance status database 322, the supporter capacity calculation unit 313 acquires the collaborator organization name 504, the capacity 505 and the value 507 of each supporter which has already started to support another support recipient at the discretion of the on-site staff. In the supporter capacity table 720 in the capacity database 324, the supporter capacity calculation unit 313 overwrites the value 715 of the capacity 725 of the supporter 721 matching the collaborator organization name 504, with a value obtained by subtracting the acquired value 507 of the capacity 505 from the value 715.

Thereafter, in S1110, the supporter capacity calculation unit 313 terminates the supporter capacity subtraction processing flow. According to the supporter capacity subtraction processing described above, a change in the capacity of a support requestee organization can be appropriately grasped based on conceivable factors, or such appropriate grasp enables a support recipient to appropriately select an alliance partner from which support is to be requested in the alliance partner determination processing.

Hereinafter, description is provided for a display screen example of the alliance partner determination apparatus 300. FIG. 12 illustrates an example of an alliance partner determination screen 1200 displayed in the processing S1009 and the processing S1010 in FIG. 10. The alliance partner determination screen 1200 is displayed on the input-output unit 332 of the alliance partner determination apparatus 300, and is configured to display on-site needs in the occurrence of a situation such as a disaster, the capacity of the owner organization, and a list of other organization candidates having capacities in such a way that an operator of the support recipient can select which organization to request to provide support.

The alliance partner determination screen 1200 illustrated in FIG. 12 includes an upper section and a lower section. The upper section includes a situation 1201, an on-site need 1202, and an owner organization capacity 1203. The situation 1201 includes items such as “TYPE” indicating a summary of an analysis result obtained from the analysis result table 400 (for example, an earthquake, a torrential rain during a large scale event, or the like), “DATE-AND-TIME” at which the situation occurred, and “LOCATION” indicating a location where the situation occurred. These kinds of information are basically information acquired from the analysis result table 400 of the analysis result database 321.

The on-site need 1202 includes a total of capacity (the number of staffs in the example of FIG. 12) requested from the site, a breakdown of the requested capacity by the attributes (skills that the supporting staffs need to have in the present embodiment), a time of “ALLOWABLE DELAY” for an arrival at the support target site, and others. These kinds of information are basically information stored in the on-site need table 800 of the on-site need database 325.

The owner organization capacity 1203 indicates the owner organization capacity allocated to the situation 1201, and includes a total of capacity (the number of staffs in the present embodiment) and a breakdown of the allocated capacity by the attributes (skills that the supporting staffs need to have in the present embodiment), and others. These kinds of information are basically information acquired from the owner organization capacity allocation table 710 of the capacity database 324.

The lower section of the screen 1200 of FIG. 12 presents a list of other organization candidates having capacities, and includes a request 1204, a supporter 1205, a requested number of staffs 1206, an expected delay 1207, an acceptance status 1208, an accepted number of staffs 1209, a total 1210, check boxes 1211, and a request send button 1212.

The request 1204 is a field where the check boxes 1211 are displayed. The supporter 1205 presents organization candidates each estimated to have support capacity that can be provided to the owner organization. The requested number of staffs 1206 presents the support capacity to be requested to the supporter organization, which is determined in S1009 of FIG. 10. The expected delay 1207 presents an expected delay time, calculated in S1105 of FIG. 11, for an arrival of the organization at the site. The acceptance status 1208 presents reply information on a reply from another organization to each support request which the operator on the support recipient side has made by operating the request send button 1212. The accepted number of staffs 1209 presents a part of the reply information, i.e., the value of the capacity that can be provided for the request by each supporter.

The total 1210 is a total value of the accepted number of staffs 1209. The check boxes 1211 are check boxes for receiving a selection by the operator as to which organization (s) to request support among the organization candidates. The request send button 1212 is a button operated by the operator when the operator actually sends the support request to the candidate organization selected in the check box 1211. The example of FIG. 12 presents a state where the operator on the support recipient side has selected the B station and the C station as support requestees, has received an acceptance reply to this request from the B station, and waits for a reply from the C station.

In the example of FIG. 12, the display order of the alliance partner candidates is the descending order of the value of the requested number of staffs (the value 727 of the capacity 725) as described above. Instead of this display order, the supporter candidates may be displayed in the ascending order of distance from the owner organization or alliance partner candidates may be displayed in accordance with a priority order which is determined in advance among organizations.

On the alliance partner determination screen 1200 of the present embodiment, the support recipient side is enabled to select other organizations while viewing a list of other organizations expected to have capacities needed by the support recipient side, and to make support requests to the selected organizations. Thus, in order to compensate for a shortage of the capacity of the owner organization, the support recipient side can make support requests to other organizations that may be able to provide necessary support.

Hereinafter, description is provided for owner organization capacity update processing accompanying the occurrence of a situation such as a disaster in the present embodiment. FIG. 13 presents an example of a processing flow which is executed to detect the occurrence of a certain situation, to receive information on damage of the owner organization from an affected site, and to update the capacity of the owner organization.

In the first place, in S1300, the processor 330 of the alliance partner determination apparatus 300 of any of the support recipient and the supporter starts the owner organization capacity update processing flow. In S1301, the situation analysis result acquisition unit 311 acquires an alert indicating a detection of the occurrence of a situation from the various-sensors system 240 via the communication unit 331. The present embodiment is described based on the assumption that a situation having a torrential rain during a large scale event occurs.

In S1302, the owner-organization capacity allocation unit 315 acquires on-site conditions (the damage in the case of the occurrence of a disaster, the congestion in the case of the holding of an event, or the like) via the communication unit 331. The on-site conditions indicate how long the capacity (category, value, attribute) of the owner organization will be unavailable. The on-site conditions may be acquired in a way, using a telephone, facsimile or the like, independent of the functions of the alliance partner determination apparatus 300, and may be inputted to the alliance partner determination apparatus 300 by the operator via the input-output unit 332. Note that, if the on-site conditions are difficult to acquire from the site, the owner-organization capacity allocation unit 315 may estimate the on-site conditions in the same manner as in S1102 of FIG. 11, in which how much the capacity of the owner organization is affected by the damage or the like is estimated based the analysis result table 400 in the analysis result database 321, and the capacity impact table 900 and the organization location table 910 in the site-impact management database 326.

Then, in S1303, the owner-organization capacity allocation unit 315 updates the owner organization capacity allocation table 710 based on the on-site conditions acquired in S1302. Specifically, the owner organization capacity (category, value, attribute) in the on-site conditions is stored into the category 714, the value 715, and the attribute 716 of the capacity 713 in the owner organization capacity allocation table 710. In addition, the period in the on-site conditions is stored in the period:start 711 and the period:end 712 in the owner organization capacity allocation table 710. Moreover, “disaster-damaged”, for example, is stored in the situation 717 in the owner organization capacity allocation table 710.

In S1304, the owner-organization capacity allocation unit 315 acquires information on the owner organization which has already started to collaborate with and support a support recipient at the discretion of the on-site staff, from the site coordination apparatus 260 via the communication unit 331, and stores the acquired information in the on-site discretionary collaborator table 500 of the alliance status database 322.

Then, in S1305, from the on-site discretionary collaborator table 500 of the alliance status database 322, the owner-organization capacity allocation unit 315 extracts a record in which the collaborator organization name 504 indicates the owner organization as a supporter having already started to support a support recipient at the discretion of the on-site staff, and acquires the capacity 505, the organization name 503 indicating the support recipient, and the update time 502 from the extracted record. Then, the value 507 of the capacity 505 in the record in which the collaborator organization name 504 matches the owner organization is stored in the value 715 of the capacity 713 in the owner organization capacity allocation table 710 of the capacity database 324. Moreover, “on-site discretionary support for the organization name 503” is stored in the situation 717 and the update time 502 is stored in the period:start 711. Meanwhile, no value is stored in the period:end 712 in order to indicate that the period is not determined yet.

In S1306, the owner-organization capacity allocation unit 315 terminates the owner organization capacity update processing flow. According to the owner organization capacity update processing described above, a reduction in the capacity of the owner organization due to support already started at the discretion of the on-site staff can be timely grasped, which enables more accurate estimation of a necessary capacity to be requested from support requestees.

Hereinafter, description is provided for alliance partner acceptability determination processing in the present embodiment. FIG. 14 is an example of a processing flow of receiving a support request from a support recipient, determining whether or not to accept it, and giving a reply about the acceptability of the request to the support recipient. The alliance partner acceptability determination processing is processing executed by the alliance partner determination apparatus 300 of an organization which receives a support request from the alliance partner determination apparatus 300 on the support recipient side in FIG. 10.

Firstly, in S1400, the processor 330 of the alliance partner determination apparatus 220 of the supporter starts the processing flow of alliance partner acceptability determination. This processing flow presents processing entirely executed by the acceptance/rejection determination unit 317. In S1401, the acceptance/rejection determination unit 317 receives a support request from the alliance partner determination apparatus 200 of the support recipient via the communication unit 331. The request includes items of a capacity (category, value, attribute) and a period (start, end).

In S1402, the acceptance/rejection determination unit 317 determines whether or not the support recipient 200 which requests support is an organization with which the owner organization has already signed an agreement to provide support in time of emergency. In this step, the acceptance/rejection determination unit 317 refers to the capacity default value table 600 of the cooperation rule database 323, and makes the determination by checking whether or not a pair of the owner organization and the support recipient 200 is present among pairs of the supporter 602 and the support recipient 603. If the pair is determined as present, the processing advances to S1403. If the pair is determined as absent, the processing advances to S1406.

Then, in S1403, the acceptance/rejection determination unit 317 determines whether or not the capacity of the owner organization can be allocated to the support recipient 200. In this step, the determination processing is performed based on whether or not the owner organization capacity allocation table 710 of the capacity database 324 has a record in which the capacity 713 matches the capacity in the support request received in S1401, the period:start 711 and the period:end 712 specify a period covering the period (start, end) in the support request, and the situation 717 is “off duty” or “on regular duty”. If the record is determined as present, the processing advances to S1404. If the record is determined as absent, the processing advances to S1406.

In S1404, the acceptance/rejection determination unit 317 updates the record detected in S1403 in the owner organization capacity allocation table 710 by overwriting the situation 717 with “support for the support recipient 200” and overwriting the period:start 711 and the period:end 712 with the period (start, end) in the support request. In this way, the capacity of the owner organization is allocated to the support request from the support recipient 200.

Note that a time required to travel to a location specified by the latitude 912 and the longitude 913 in a record in which the organization name 911 matches the support recipient in the organization location table 910 of the site-impact management database 326 may be acquired by using the route search system 230, and then whether the period in which the owner organization capacity is allocatable covers the period requested by the support request may be determined based on the period (start) in the support request moved ahead with the travel time taken into account.

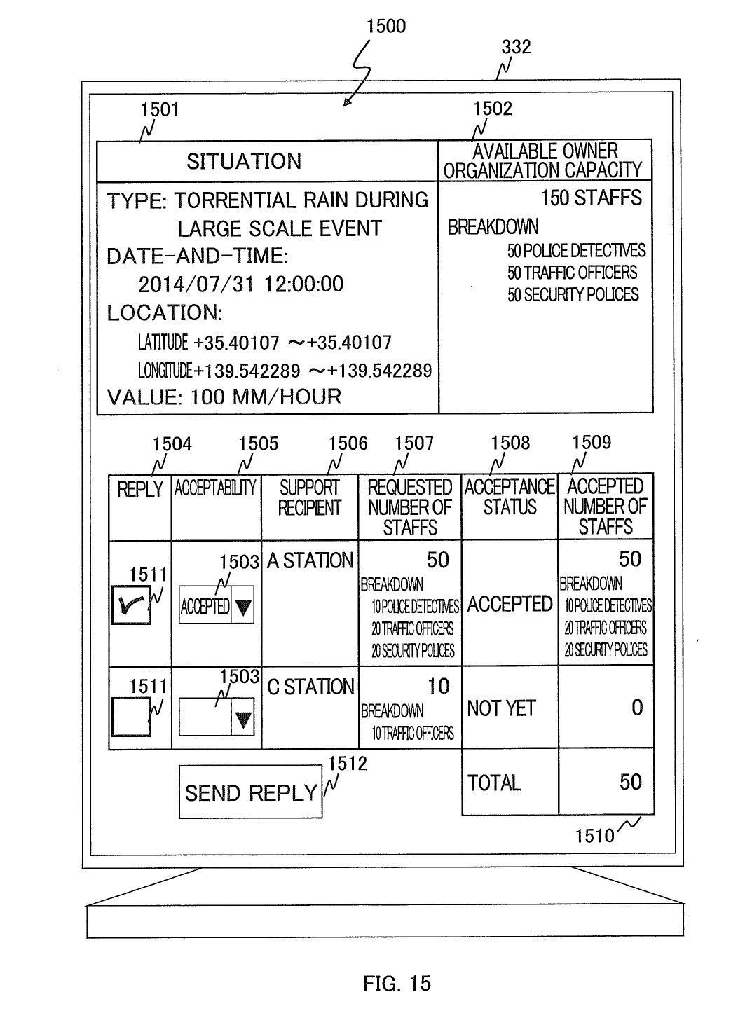

Thereafter, the acceptance/rejection determination unit 317 outputs a reply screen for the support request from the support recipient 200 to the input-output unit 332, and receives a determination of acceptance from the operator. On the other hand, in S1406, the acceptance/rejection determination unit 317 outputs the reply screen for the support request from the support recipient 200 to the input-output unit 332, and receives a determination of acceptance-rejection from the operator. The reply screen is described later in reference to FIG. 15. The acceptance/rejection determination unit 317 terminates the alliance partner acceptability determination processing flow in S1407.

The acceptance/rejection determination processing described above enables an organization receiving a support request to determine quickly and accurately whether its owner organization capacity can meet the need in the support request, and to quickly reply to the support recipient as to whether the support request is accepted or not based on the determination result.

FIG. 15 illustrates an example of a support request reply screen 1500 displayed in S1405 and S1406 in FIG. 14 for a support request from a support recipient. The support request reply screen 1500 is displayed on the input-output unit 332 of the alliance partner determination apparatus 300 and is configured to display support requests from other organizations in the occurrence of a situation such as a disaster, the owner organization capacity, and a list of other organizations making support requests in such a way that an operator can select which organization to support. The support request reply screen 1500 includes an upper section and a lower section as illustrated in FIG. 15. The upper section includes a situation 1501, and an available owner organization capacity 1502. The situation 1501 includes items such as “TYPE” indicating a summary of an analysis result obtained from the analysis result table 400 (for example, an earthquake, a torrential rain during a large scale event, or the like), “DATE-AND-TIME” at which the situation occurred, and “LOCATION” indicating a location where the situation occurred. These kinds of information are basically information acquired from the analysis result table 400 of the analysis result database 321. The available owner organization capacity 1502 indicates an available capacity of the owner organization, and includes a total of capacity (the number of staffs in the present embodiment) and a breakdown of the available capacity by the attributes (skills that the supporting staffs have in the present embodiment), and others. These kinds of information are basically information in the owner organization capacity allocation table 710 of the capacity database 324.

The lower section of the reply screen 1500 presents a list of other organizations making support requests, and includes a reply 1504, an acceptability 1505, pull-down menus 1503, a support recipient 1506, a requested number of staffs 1507, an acceptance status 1508, an accepted number of staffs 1509, a total 1510, check boxes 1511, and a reply send button 1512.

The reply 1504 is a field where the check boxes 1511 are displayed. The acceptability 1505 is a field where the pull-down menus 1503 are displayed. The support recipient 1506 presents organizations which are making support requests to the owner organization. The requested number of staffs 1507 presents the capacities requested by the support recipients. The acceptance status 1508 presents acceptance information indicating whether or not an operator of the owner organization has sent a reply to a request from another organization by pressing down the reply send button 1512, and whether the owner organization consequently accepts or rejects the request. The accepted number of staffs 1509 presents a part of acceptance information, i.e., the values of the capacity that can be actually provided for the request. The total 1510 is a total value of the accepted number of staffs 1509. The check boxes 1511 are check boxes that allow the operator to select to which organization to send an acceptance or rejection reply among the other organizations. The pull-down menu 1503 is for displaying two options of “accepted” and “rejected” as to the acceptability of each request, and is used by the operator to input an acceptance or rejection reply to the request . The reply send button 1512 is a button pressed down by the operator when the operator actually sends an acceptance or rejection reply inputted in the pull-down menu 1503 to the organization selected in the check box 1511. The example of FIG. 15 presents a state where a reply has been sent to the A station as a support recipient which has made a support request, the reply indicating that the capacity of the displayed values can be offered for support.

In the example of FIG. 15, the display order in the support recipient 1506 is a descending order of the value of the requested number of staffs 1507. Instead, support recipients may be displayed in an ascending order of distance from the owner organization, or alliance partner candidates may be displayed in accordance with a priority order which is determined in advance among organizations.

On the support request reply screen 1500 in the present embodiment, the support capacity possessed by a supporter organization having received support requests, and the capacities requested by the support requests are displayed in a comparable manner. Thus, with its own support capacity taken into account, the supporter organization having received the support requests can easily determine whether or not to support each support recipient.

It should be noted that the present invention is not limited to the foregoing embodiment, but may include various modifications. For example, the foregoing embodiment is described in detail for the purpose of making the present invention understood easily, and the present invention should not be necessarily limited to that including all the constituents described above. In addition, any of the constituents of the embodiment may be replaced with another constituent, or another constituent may be added to any of the constituents of the embodiment.

What is claimed is:

1. An alliance partner determination apparatus for a certain one of a plurality of organizations which provide support to each other in case of occurrence of a given situation, the apparatus configured to assist the certain organization to determine an alliance partner to which the certain organization is to make a support request in order to cope with the situation, the apparatus comprising:
a situation analysis result acquisition unit configured to acquire information including a type and a scale of the situation occurring or having occurred; and
a supporter capacity calculation unit configured to perform processing based on the information including the type and the scale of the situation, the processing including
acquiring a response capacity available in the certain organization, and a support capacity expected to be provided by a partner organization that is another organization having already built a support provision cooperation relationship with the certain organization, and
estimating a reduction in the support capacity of the partner organization due to the situation to calculate an available support capacity expected to be actually provided by the partner organization,
wherein information on the partner organization having the available support capacity and the available support capacity is outputted together.

2. The alliance partner determination apparatus according to claim 1, wherein
the supporter capacity calculation unit acquires a relationship between a support request and an acceptance which have been already made by other organizations in order to cope with the situation, and
if the partner organization is one of the other organizations, the supporter capacity calculation unit subtracts, from the support capacity of the partner organization, a support capacity of the partner organization already provided to the other organization.

3. The alliance partner determination apparatus according to claim 1, wherein
if organizations having no cooperation relationship with each other have already made a support request and an acceptance therebetween at discretion of on-site staff, and if the organization which provides the support is the partner organization, the supporter capacity calculation unit acquires a support capacity of the partner organization already provided at the discretion of the on-site staff, and subtracts the acquired support capacity from the support capacity of the partner organization.

4. The alliance partner determination apparatus according to claim 1, wherein
if the supporter capacity calculation unit determines that an impact of the occurrence of the situation spans the partner organization as a support requestee, the supporter capacity calculation unit subtracts, from the support capacity of the partner organization specified in advance in the cooperation relationship, an estimated reduction volume in the supporter capacity of the partner organization due to the impact.

5. The alliance partner determination apparatus according to claim 1, wherein
the supporter capacity calculation unit acquires a support-needing period during which the certain organization needs support, and a supportable period during which the partner organization as a support requestee is capable of providing support, and
if determining that the support-needing period is covered by the supportable period, the supporter capacity calculation unit determines that a support request to the partner organization is possible.

6. The alliance partner determination apparatus according to claim 5, wherein
if the supporter capacity calculation unit determines that the impact of the occurrence of the situation delays a support starting time at which the partner organization as the support requestee is expected to start supporting the certain organization as a support recipient, the supporter capacity calculation unit delays the support starting time specified in the cooperation relationship according to the determination result.

7. The alliance partner determination apparatus according to claim 1, further comprising a certain-organization capacity allocation unit configured to update a support capacity possessed by the certain organization based on a reduction volume in the response capacity of the certain organization due to an impact of the situation, and a support capacity of the certain organization having already provided to another organization at discretion of on-site staff.

8. The alliance partner determination apparatus according to claim 1, further comprising an acceptance/rejection determination unit configured to, when receiving a support request from another organization, determine whether or not the certain organization has a cooperation relationship with the support requesting organization and whether the certain organization possesses a support capacity for responding to the support request, and send the support requesting organization a reply indicating an acceptance of the support request if the acceptance/rejection determination unit determines that the certain organization has the cooperation relationship with the support requesting organization and possesses the support capacity for responding to the support request.

9. The alliance partner determination apparatus according to claim 1, wherein
when the information on the partner organization having the available support capacity and the available support capacity is outputted together, the information is displayed such that whether or not a reply to the support request to the partner organization has been received and whether or not the reply, if received, indicates an acceptance of the support request are displayed in a distinguishable manner.

10. An alliance partner determination method for a certain one of a plurality of organizations which provide support to each other in case of occurrence of a given situation, the apparatus configured to assist the certain organization to determine an alliance partner to which the certain organization is to make a support request in order to cope with the situation, the apparatus comprising,
the method, executed by a computer including a processor and a memory, comprising:
acquiring information including a type and a scale of the situation occurring or having occurred;
based on the information including the type and the scale of the situation, acquiring a response capacity available in the certain organization, and a support capacity expected to be provided by a partner organization that is another organization having already built a support provision cooperation relationship with the certain organization, and estimating a reduction in the support capacity of the partner organization due to the situation to calculate an available support capacity expected to be actually provided by the partner organization; and
outputting information on the partner organization having the available support capacity and the available support capacity together.
